(19) United States
(12) Patent Application Publication
(10) Pub. No.: US 2007/0230302 A1
(43) Pub. Date: Oct. 4, 2007

(54) OPTICAL DISC RECORDING PROTECTION

(75) Inventor: Chih-yuan Chen, Hsin-Chu City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Media Tek Inc., Hsin-Chu (TW)

(21) Appl. No.: 11/616,431

(22) Filed: Dec. 27, 2006

Related U.S. Application Data
(60) Provisional application No. 60/787,239, filed on Mar. 28, 2006.

(51) Int. Cl. G11B 7/00

(52) U.S. Cl. 369/53.16

(57) ABSTRACT

A method and device for protecting an optical disc from being damaged when a defect is encountered during recording. According to the present invention, when a defect is encountered during recording, the length of the defect is measured. The recording is stopped when the length of the defect exceeds a threshold. After the defect has been passed, the recording can be resumed.

### CROSS REFERENCE OF RELATED APPLICATIONS

The present application claims the priority of the Provisional Application Ser. No. 60/787,239, entitled “Apparatus and Method of Recording Data on Optical Disc”, filed on Mar. 28, 2006.

### TECHNICAL FIELD OF THE INVENTION

The present invention relates to optical disc recording, and more particularly, to a protection mechanism to prevent the optical disc from being damaged in the recording process, such as a damage caused by an abnormal track-slipping phenomenon of a pick-up head due to a significantly long defect on the disc.

### BACKGROUND OF THE INVENTION

As the spread of multi-media applications rises, large capacity of an optical disc becomes extremely desirable. To increase storage capacity, high-density optical discs have been developed, such as Blu-ray disc (BD) and HD DVD. The track pitch of a high-density disc is reduced to half or even one-fifth of that of the conventional CD and DVD discs. For example, the track pitches of the conventional CD and DVD discs are respectively 1.6 um and 0.74 um, while the track pitches of BD and HD DVD discs are respectively 0.32 um and 0.40 um. However, in comparison with the conventional optical disc, the existence of defect is a critical and serious problem to the high-density disc. As a pick-up head follows the track of a disc and encounters a defect, a severe problem may happen. That is, the defect may cause the pick-up head to deviate from the track center or even improperly enter into a neighboring track when the length of the defect is considerably long. In a process of reading an optical disc, such a deviation from the track can be easily overcome by a re-reading operation because the reading power is insignificant to cause any mark formation or erasure on the disc. However, such deviation from the track may be an irretrievable error in a recording process since the data or even the recordable areas of the neighboring track may be damaged by the high writing power. Once the existing data recorded on the disc is overwritten by a high writing power, it is almost impossible to recover the damaged data.

Defects such as scratches, dots, dusts and fingerprints are often seen on an optical disc as the disc is improperly stored or used. As mentioned, when the pick-up head encounters a defect, it may deviate from the target track. This is because a servo controller may fail to correctly control the lens of the pick-up head due to the improperly obtained signals from the wrong location, so that the lens may not keep aiming at the target track. Some methods have been proposed to control the lens movement of the pick-up head so as to limit the deviation. For example, a control signal to the pick-up head can be held, or a tracking control signal is switched to a lower frequency signal. However, such methods can only reduce the deviation of the pick-up head from the target track, but not eliminate such deviation thorough. If the length of the defect is significantly long, the pick-up head is likely to deviate to a wrong track such as the neighboring track. As described, the cause for such a deviation is that a servo which controls the pick-up head fails to keep the pick-up head on the track with radial run-out variation, since the correct tracking information is not available as encountering the defect on the disc.

### SUMMERY OF THE INVENTION

To overcome the problem described above, there is a need for a scheme to alarm when such a deviation of the pick-up head from the target track, especially when recording data to the optical disc, is likely to occur, so that the pick-up head can be stopped and a proper measure can be applied to deal with the defect.

An objective of the present invention is to provide a method for protecting an optical disc from being damaged when a defect is encountered during a recording process of the optical disc. By the method of the present invention, severe deviation of a pick-up head from the target track is avoided, so as to prevent data and recordable areas of other tracks from being damaged when the pick-up head encounters a defect of a significant length.

Another objective of the present invention is to provide a device for protecting an optical disc from being damaged when a defect is encountered during a recording process. The protection device may assist a recording apparatus to avoid damaging an optical disc when a pick-up head of the recording apparatus encounters a defect on the disc.

In accordance with an aspect of the present invention, the protection method stops recording when the length of a defect during a recording process exceeds a threshold. The threshold can be predetermined according to at least one of the track radius, run-out, track pitch, or the rotation speed of the disc. The threshold can also be determined according to empirical values obtained by experimentation. In addition, the threshold can be a variable or constant for the whole disc. The recording is resumed after the defect is passed. Such a defect with a length that exceeds the threshold can be marked as a skipped defect area, so that the pick-up head can directly skip the defect whenever the pick-up head encounters it.

In accordance with another aspect of the present invention, the protection device measures a length of a defect during recording of data to an optical disc, and stops the recording when the defect length exceeds a threshold. The threshold can be predetermined as desired or based on any proper algorithm. The protection device resumes the recording after the defect is passed. The device marks such a defect as a skipped defect area when the length of the defect exceeds the threshold, so that the defect can be directly skipped whenever it is encountered.

### BRIEF DESCRIPTION OF THE DRAWINGS

The present invention will be further described in details in conjunction with the accompanying drawings.

FIG. 1 schematically illustrates an eccentric optical disc;

FIG. 2 schematically illustrates radial run-out of a track of an optical disc;

FIG. 3 is a diagram showing relationships between tolerable defect lengths and track radius for BD and DVD discs;

FIG. 4 is a diagram showing relationships between tolerable defect lengths and track radius for different run-out magnitudes;

FIG. 5 shows experiment results for a Philips BD-R 25G defect test disc;

FIG. 6 is a block diagram schematically illustrating an optical disc recording apparatus in accordance with the present invention; and

FIG. 7 is a flow chart showing a method in accordance with an embodiment of the present invention.

### DETAILED DESCRIPTION OF THE INVENTION

In reading/writing procedure for an optical disc, a pick-up head may deviate from a target track when encountering a defect of a significant length on the disc. Track-slipping may even happen when the defect is considerably long. The so-called track-slipping means that the pick-up head deviates from the target track and enters into a wrong track. According to an embodiment of the present invention, especially in writing (recording) the disc, the large write power of the pick-up head is switched off or changed to a small read power whenever a defect with a length, which exceeds a predetermined threshold, is encountered. After the writing operation is suspended, the defect can be then processed properly. The recording operation can be resumed from a position of the disc which is determined by the defect management function.

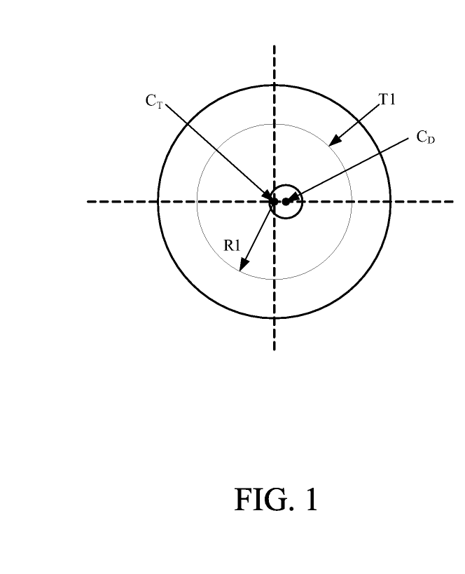

The threshold of the defect length, which is used as a reference for deciding whether the recording operation should be suspended, can be predetermined in any proper manner. For example, the threshold can be determined according to empirical values obtained by experimentation. Alternatively, the threshold can be determined by a specific algorithm. An example will be described as follows with reference to FIG. 1. In general, tracks of an optical disc are spiral starting from inner side to outer side. A track T1 of one revolution has almost the same distance (radius R1) except the track pitch to the center hole of the disc. Practically, an optical disc is eccentric due to imperfections in manufacturing of the optical discs. “Eccentricity” of an optical disc is defined as the distance between the center of the tracks C_{T} and the center of the inner hole C_{D}. The radial run-out is also used to describe the eccentricity of a disc. When the tracks on the disc are not circular but oval, run-out occurs. In addition, run-out may also occur when the disc wobbles instead of rotating in a perfectly circular manner. Furthermore, run-out occurs when the center of the disc is not concentrically aligned with the center of the axis of rotation.

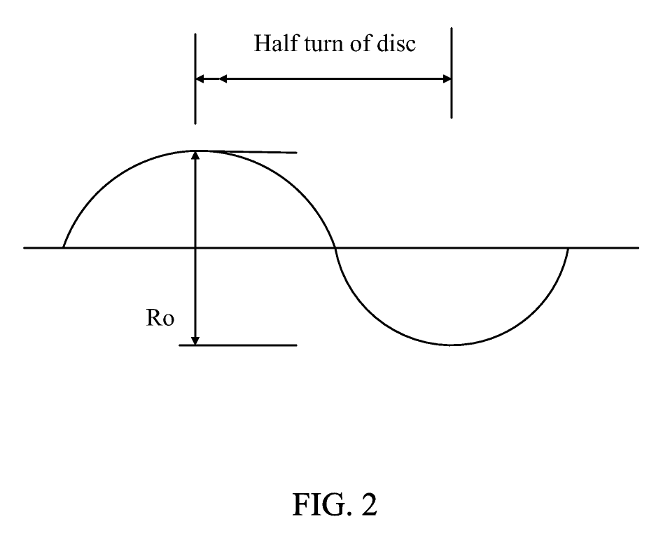

FIG. 2 schematically illustrates radial run-out of a track of an optical disc. As shown, the run-out varies as a sine curve. When the disc has rotated a half turn, the radius difference reaches the maximum value R₀. The run-out can be expressed as R₀ sin ωt, where ω indicates the angular velocity of rotation. For a specific track, the radius thereof can be expressed as:

r(t)=R+(R₀/2)sin ωt (1)

where R denotes the average radius of a specific track. As described and shown, when the disc rotates for half of a turn, the radius difference reaches the maximum value R₀/2. That is, for one specific track, after the pick-up head has moved for a path of πR, the worst run-out is R₀. Assuming a defect length is D, the maximum acceptable deviation is Tp/N (where Tp is the track pitch, N is an integer), then we can use the following equation to calculate D:

$$\frac{π R}{{R}_{0}} = \frac{D}{Tp / N} \qquad ( 2 )$$

The above equation (2) can be derived as:

$$D = \frac{π RTp}{{NR}_{0}} \qquad ( 3 )$$

Table 1 shows the track pitches and allowable maximum radial run-out values for various disc formats.

TABLE 1

| | Disc Type | | |
|---|---|---|---|
| | BD | HD DVD | DVD |
| Track Pitch (um) | 0.32 | 0.4 | 0.74 |
| Allowable Max Radial Run-out (um) | 75 | 50 | 70 |

### As can be seen from Table 1, the defect tolerance is the most critical for BD disc since the track pitch thereof is very small, while the radial run-out thereof may be large.

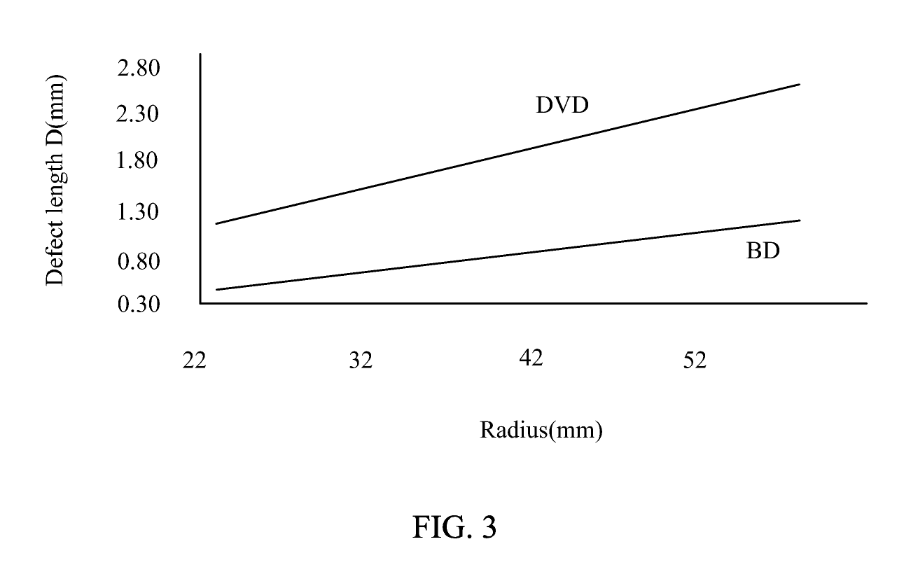

FIG. 3 is a diagram showing relationships between tolerable defect lengths and track radius for BD and DVD discs with the same radial run-outs of 25 um. In addition, the maximum tolerable deviation is Tp/2. As can be seen from the diagram, the tolerance of defect length for a DVD disc is much greater than that of for BD disc. That is, track-slipping does not easily occur to the DVD but easily occurs to the BD for the same defect length.

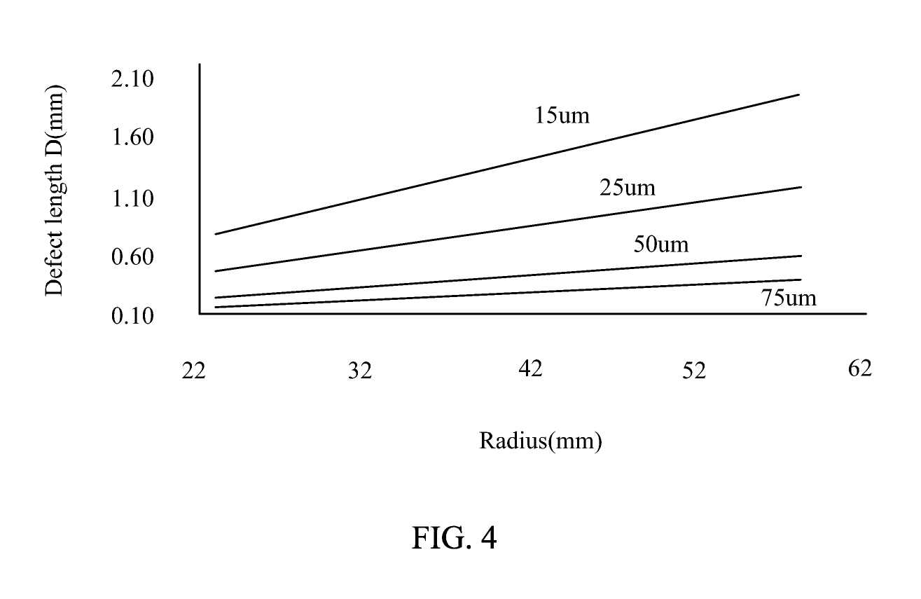

Now a Blu-ray disc (BD) is described as an example. The track radii of the Blu-ray discs range from 23 mm to 58 mm. The maximum radial run-out for a disc is defined as 75 um in the Blu-ray Disc specification. FIG. 4 shows calculation results of defect lengths with respect to different radial run-outs of a BD disc. This diagram shows the defect threshold value D calculated by equation (3) for different run-out magnitudes 15 um, 25 um, 50 um and 75 um when N=2, that is, the maximum acceptable deviation is Tp/2. As shown, the greater the track radius, the longer the defect threshold D. In addition, when the run-out is severer, the limit of the acceptable defect length is more critical.

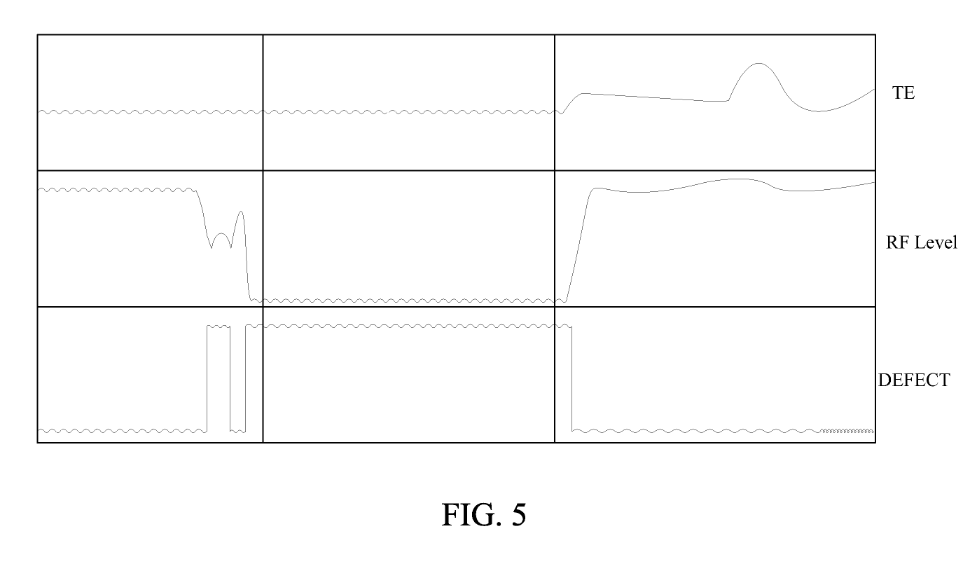

FIG. 5 shows experiment results for a Philips BD-R 25G defect test disc. The disc has a black dot at a position that radius R=50 mm. The dot size is 1.8 mm. Radial run-out is equal to 41 tracks, which is 13.1 um. Then, the tolerable defect length D calculated by the Equation (3) is 1.93 mm. It is found that track-slipping occurs when the defect at the position has a length of 4.92 m/s (1×rotation speed)×390 ms (a period from the pick-up head encounters the defect to track-slipping occurs)=1.91 ms, which is closed to the calculated value.

As can be seen from FIG. 4, the maximum tolerable defect length for the radial run-out of 75 um as specified in BD Book is quite short, which is 150 um at innermost radius of 23 mm and 390 um at outermost radius of 58 mm. This conforms to the maximum local defect size of diameter 150 um for a “good” blank disc. However, larger defects easily occur on the disc after the disc has been used for a long time or re-used repeatedly. Unintended track deviation may occur during recording as encountering a significant defect and thus damage the data on neighboring tracks. The present invention provides a scheme to interrupt recording when a significant defect is encountered to avoid the data from being damaged

In practice, the tolerable defect length could be longer than the threshold value calculated by Equation (3) by means of assistance of some servo control techniques such as a real-time learning run-out compensation scheme to learn the control values for compensation and store the control values in a memory.

In addition to the factors described above, the rotation speed also influences the defect tolerance. For example, the bandwidth of a tracking loop of a disc drive is about 5 kHz˜10 kHz. For bandwidth of 5 kHz, the disc drive can tolerate an error duration of about 400 us. If the linear velocity for BD 1× is about 5 m/s, the defect length for a pick-up head to pass in 200 us is about 2 mm.

As described above, to determine the threshold for the tolerable defect length, many factors such as track radius, run-out, track pitch and rotation speed can be considered. Empirical values obtained by experimentation can also be considered. Other factors can also be considered as desired. Alternatively, the threshold can be a constant for the whole disc.

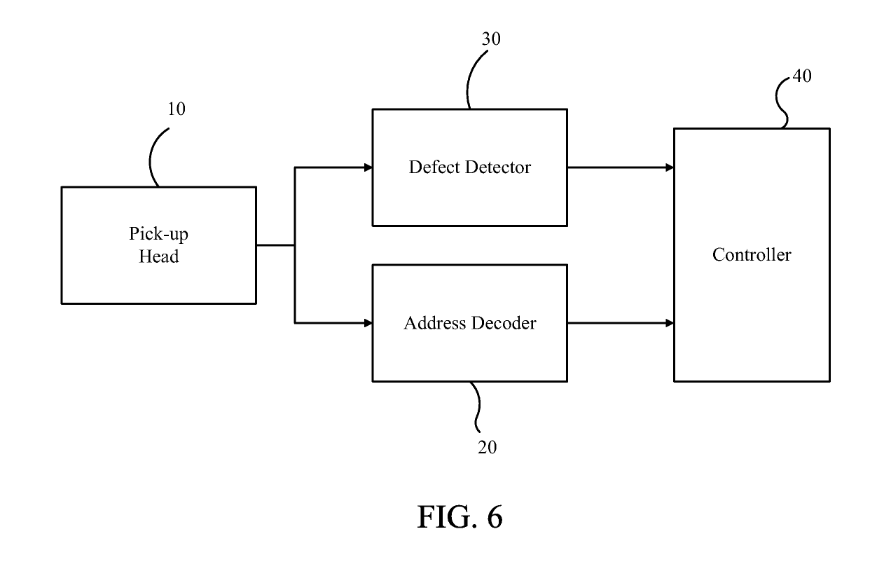

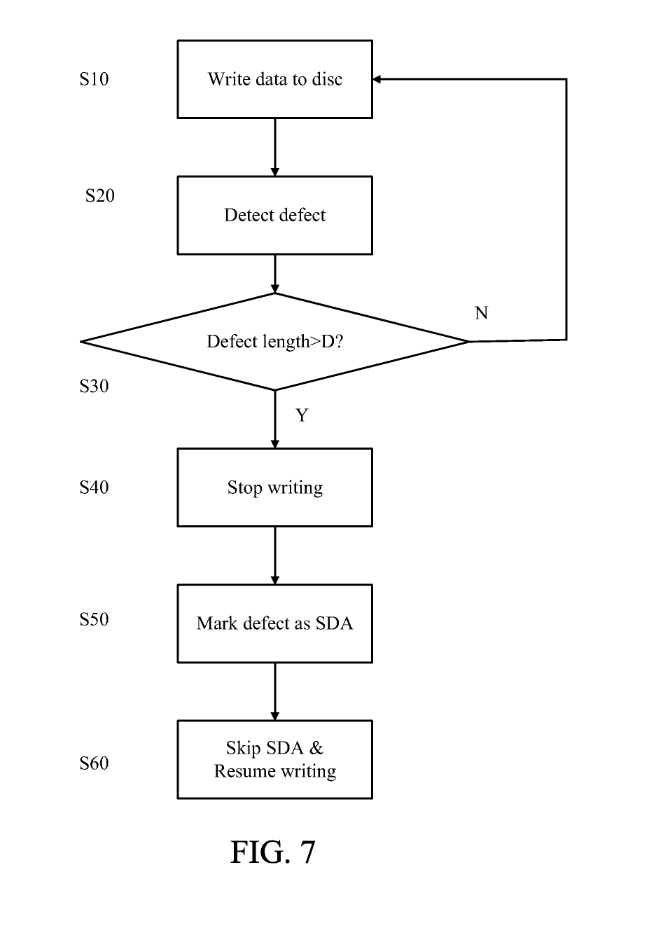

The embodiment of the present invention will be further described with reference to FIGS. 6 and 7. FIG. 6 is a block diagram schematically showing the main structure of a recording apparatus in accordance with an embodiment of the present invention. For the sake of simplification and clarity, only the components concerning the feature of the present invention are shown. The apparatus at least has a pick-up head 10, an address decoder 20, a defect detector 30 and a controller 40. FIG. 7 is a flow chart showing a method in accordance with an embodiment of the present invention. In the present embodiment, the pick-up head 10 writes data to an optical disc (not shown), which is carried by a spindle (not shown), as indicated by Step S10. The address decoder 20 is used for decoding position information read from the disc to obtain a physical address. The defect detector 30 detects a defect when the pick-up head 10 encounters a defect (Step S20). In accordance with the present invention, the defect detector 30 measures the length of the defect. In the present embodiment, the defect detector 30 checks if the defect length exceeds a threshold D, which can be predetermined as described above (Step S30). If so, the defect detector 30 notifies the controller 40 by sending a signal, for example, that the defect length exceeds the threshold D. In another embodiment, the defect detector 30 executes no determination per se. The defect detector 30 simply provides the controller 40 with the defect length. Then the controller 40 determines if the defect length exceeds the threshold D. No matter the determination operation is executed in the defect detector 30 or the controller 40, the controller 40 stops the writing operation once the defect length is determined to exceed the threshold D (Step S40). As described, the defect detector 30 and the controller 40 cooperatively constitute a protection mechanism, which can be referred to as a protection device, for the recording apparatus in accordance with the present invention.

After writing operation is stopped, various defect management schemes can be executed. As the writing operation is stopped, the laser power is switched from a large write power to a small read power to prevent from damaging the recordable area or the recorded data on the neighboring tracks. The defect can be marked and registered. In addition, the address where the pick-up stops is stored. The stored address can be a physical address or a data address. In addition, an address of a spare area of the disc can be assigned to be used to record a replacement for the defect. The data to be originally recorded to the defect position is stored and recorded in a spare area reserved for replacement. The timing to record the spare area can be decided by a specific defect management scheme. For example, the pick-up head can be moved to the spare area to record the data once after the writing operation is stopped. After recording the spare area, the pick-up head is moved to the next recordable area to resume the writing operation. In some situations, recording the data to the spare areas can be executed after many defective areas are detected and the data originally to be recorded to these defective areas are stored in a memory. The writing operation for recording the data is resumed once after passing the defect areas till an operation of recording data on to the spare area is decided by the defect management scheme.

To improve efficiency of defect management, in accordance with the embodiment of the present invention, the defect with a length exceeding the threshold can be marked as a “skipped defect area (SDA)” (Step S50) The SDA marking operation can be done by the defect detector 30 or the controller 40 depending on the design. Whenever the pick-up head 10 encounters an SDA, the pick-up head 10 will directly skip this area without measuring the length thereof and comparing the length with the threshold. Accordingly, redundant measuring and determining processes can be omitted.

After the pick-up head 10 skips the SDA, the controller 40 resumes the writing operation (Step S60). Preferably, the writing operation is re-started immediately after the SDA. That is, the writing operation is resumed from the next recordable address from the SDA. Actually, the next recordable address can be determined by the defect management scheme for optimizing the recording time, the use of recording area and spare area, or playback performance

While the preferred embodiment of the present invention has been illustrated and described in details, various modifications and alterations can be made by persons skilled in this art. The embodiment of the present invention is therefore described in an illustrative but not in a restrictive sense. It is intended that the present invention should not be limited to the particular forms as illustrated, and that all modifications and alterations which maintain the spirit and realm of the present invention are within the scope as defined in the appended claims.

What is claimed is:

1. A recording method for an optical disc comprising:
recording data to the disc;
measuring a length of a defect when the defect is encountered; and
stopping recording if the length of the defect exceeds a threshold.

2. The method of claim 1, wherein the stopping step comprises switching off power of recording.

3. The method of claim 1, wherein the stopping step comprises switching power of recording to a lower power.

4. The method of claim 1, wherein the threshold is predetermined in accordance with at least one factor selected from a group consisting of track radius, run-out, track pitch, and rotation speed of the disc.

5. The method of claim 1, wherein the threshold is predetermined according to empirical values obtained by experimentation.

6. The method of claim 1, wherein the threshold is a constant for the whole disc.

7. The method of claim 1, further comprising storing an address where the recording is stopped.

8. The method of claim 1, further comprising marking the defect as a defective area.

9. The method of claim 1, further comprising resuming recording after the defect is passed.

10. The method of claim 9, wherein the recording is resumed at a recordable area next to the defect.

11. A recording system for an optical disc drive which has a pick-up head for emitting laser to an optical disc, the recording system comprising:
a defect detector coupled to the pickup head for detecting a defect when the pick-up head encounters the defect, and measuring a length of the defect; and
a controller coupled to the pickup head and the defect detector for stopping recording when the length of the defect exceeds a threshold.

12. The system of claim 11, wherein the controller switches off power of the pick-up head to stop recording.

13. The system of claim 11, wherein the controller switches power of the pick-up head to a lower power to stop recording.

14. The system of claim 11, wherein the defect detector notifies the controller when the length of the defect exceeds the threshold so that the controller stops recording.

15. The system of claim 11, wherein the defect detector transmits the measured length of the defect to the controller, and the controller stops recording when the length of the defect exceeds the threshold.

16. The system of claim 11, wherein the threshold is predetermined in accordance with at least one factor selected from a group consisting of track radius, run-out, track pitch, and rotation speed of the disc.

17. The system of claim 11, wherein the threshold is predetermined according to empirical values obtained by experimentation.

18. The system of claim 11, wherein the threshold is a constant for the whole disc.

19. The system of claim 11, wherein controller resumes recording after the defect is passed.

20. The system of claim 19, wherein the controller resumes recording at a recordable area next to the defect

21. A method for protecting an optical disc from being affected by a first power of laser emitted from a pickup head, said method comprising:
performing a first operation with the first power of laser; and
changing the first power when encountering a defect with a length exceeding a threshold.

22. The method of claim 21, wherein the changing step comprises switching off the first power.

23. The method of claim 21, wherein the changing step comprises switching the first power to a second power which is lower than the first power.

24. The method of claim 21, wherein the threshold is predetermined in accordance with at least one factor selected from a group consisting of track radius, run-out, track pitch, and rotation speed of the disc.

25. The method of claim 21, wherein the threshold is predetermined according to empirical values obtained by experimentation.

26. The method of claim 21, wherein the threshold is a constant for the whole disc.

27. The method of claim 21, further comprising storing an address where the power is changed.

28. The method of claim 21, further comprising resuming the operation with the first power after the defect is passed.

29. The method of claim 28, wherein the operation is resumed at a recordable area next to the defect.

30. A device for protecting an optical disc from being affected by a first power of laser emitted from a pickup head, said device comprising:
a defect detector detecting at least a defect during the pickup head performing an operation with the first power; and
a controller changing the first power when encountering a defect with a length exceeding a threshold.

31. The device of claim 30, wherein the controller switches off the first power.

32. The device of claim 30, wherein the controller changes the first power to a second power which is lower than the first power.

33. The device of claim 30, wherein the threshold is predetermined in accordance with at least one factor selected from a group consisting of track radius, run-out, track pitch, and rotation speed of the disc.

34. The device of claim 30, wherein the threshold is predetermined according to empirical values obtained by experimentation.

35. The device of claim 30, wherein the threshold is a constant for the whole disc.

36. The device of claim 30, wherein controller resumes the operation with the first power after the defect is passed.

37. The device of claim 36, wherein the controller resumes the operation at a recordable area next to the defect.
